(19) United States
(12) Patent Application Publication
(10) Pub. No.: US 2010/0150246 A1
(43) Pub. Date: Jun. 17, 2010

(54) VIDEO SIGNAL PROCESSING DEVICE

(76) Inventor: Tatsuo Kosako, Osaka (JP)

Correspondence Address: MCDERMOTT WILL & EMERY LLP, 600 13TH STREET, NW, WASHINGTON, DC, 20005-3096, US

(21) Appl. No.: 12/600,382

(22) PCT Filed: May 19, 2008
(86) PCT No.: PCT/JP2008/001242

§ 371 Date: Nov. 16, 2009

(30) Foreign Application Priority Data
May 24, 2007 (JP) 2007-137684

(51) Int. Cl. H04N 7/26

(52) U.S. Cl. 375/240.25; 375/E07.027

(57) ABSTRACT

A sub picture buffer (7) temporarily stores top field sub picture data and bottom field sub picture data which have been subjected to the run length compression. A sub picture magnifying/demagnifying unit (8) subjects the sub picture data to a display magnification process accompanied by the interpolation of line data. A sub picture output buffer (9) temporarily stores the sub picture data which has been subjected to the display magnification process. A video buffer (5) temporarily stores video packet data. A video decoding unit (10) decodes the video packet data and the sub picture data which has been subjected to the display magnification process, and combines the decoded video packet data with the decoded sub picture data and outputs the combined data thus obtained.

### RELATED APPLICATIONS

This application is the U.S. National Phase under 35 U.S.C. §371 of International Application No. PCT/JP2008/001242, filed on May 19, 2008, which in turn claims the benefit of Japanese Application No. 2007-137684, filed on May 24, 2007, the disclosures of which Applications are incorporated by reference herein.

### FIELD OF THE INVENTION

The present invention relates to a video signal processing device comprising a function for converting a display magnification ratio of a sub picture which is effective in reproducing run-length-compressed sub picture data and providing a process, such as magnification or demagnification to the data.

### BACKGROUND OF THE INVENTION

In video reproduction data recorded on a DVD video disc or the like, video data for sub images such as subtitles, which is generally called “sub picture data,” is independently recorded apart from main video data. In the structure of the sub picture data, a top field and a bottom field are defined in view of the reproduction by an interlace method. The sub picture data is recorded as runlength-compressed bit map data. A reproduction device reads the runlength-compressed bit mat data from the disc on which the video data is recorded and decodes the read data, and then combines the decoded sub picture data with the main video data (for example, see Patent Document 1).

Thus constituted, a reproduction device for reproducing, for example, DVD videos is capable of:
displaying a selection menu such as chapters; and
displaying buttons for selecting items such as games.

In the runlength-compressed sub picture data, however, each inter-line data (vertical direction) is left uncompressed. Therefore, when the sub picture data is subjected to a display magnification process (in particular, when the sub picture data is magnified), line data is repeatedly used as illustrated in FIG. 5. More specifically, the following processes are performed: the rank of a line subject to a display magnification process and a display magnification ratio are used to calculate the rank of the original line, and rounding off is used in calculating the rank.

In the data obtained after a display magnification process:
the original line of Line 1 is Line 1 according to 1/1.5≈0.67;
the original line of Line 2 is also Line 1 according to 2/1.5≈1.33;
the original line of Line 3 is Line 2 according to 3/1.5≈2;
the original line of Line 4 is Line 3 according to 4/1.5≈2.67; and
the original line of Line 5 is also Line 3 according to 5/1.5≈3.33.

When a magnification ratio is less than 100%, a demagnification process is performed by thinning out line data. At that time, the following processes are performed: the rank of a line subject to a display magnification process and the display magnification ratio are used in the calculation of the rank of the original line, and rounding off is used in calculating the rank.

In the data obtained after a display magnification process:
the original line of Line 1 is Line 1 according to 1/0.8≈1.25;
the original line of Line 2 is Line 3 according to 2/0.8≈2.5
the original line of Line 3 is Line 4 according to 3/0.8≈3.75

In this case, Line 2 is thinned.

Patent Document 1: U.S. Pat. No. 5,758,007

Patent Document 2: H05-191633 of the Japanese Patent Applications Laid-Open

Patent Document 3: U.S. Pat. No. 6,803,968

Patent Document 4: US 2004/0133926

Patent Document 5: H05-250468 of the Japanese Patent Applications Laid-Open

Patent Document 6: U.S. Pat. No. 6,526,214

Patent Document 7: U.S. Pat. No. 6,115,529

Patent Document 8: U.S. Pat. No. 5,731,847

### DISCLOSURE OF THE INVENTION

### Problem to be Solved by the Invention

A reproduction device, however, may need to deal with the following case:
a title recorded according to the NTSC method is displayed on a display according to the PAL method;
a title recorded according to the PAL method is displayed on a display according to the NTSC method; or
sub picture data having a fixed size and main video data having a variable size are overlapped to be displayed in the same size.

Therefore, a function for converting the magnification ratio of sub picture data independently from main video data is required.

An example of a technology for subjecting video data to the display magnification process at its data stage is a line interpolation method in which upper and lower scan lines are used. This technology, however, is not applied to the process of the display magnification ratio of sub picture data in a DVD reproduction device.

Since video data generally represents a natural image, it is indispensable to execute a display magnification process having a characteristic like linear interpolation. In contrast to video data, in sub picture data, pixels constituting each pixel are only of a few types. Therefore, even if a medium color is calculated by linear interpolation, a color which agrees with the calculated medium color is not always found in the permissible pixels. As a result, the medium color has to be replaced with the color of the pixel which has a color closest to the medium color.

In sub picture data, a top field and a bottom field are differently set. Assume that a rectangular frame illustrated in FIG. 2 is displayed, the upper and lower sides form the top field alone and the left and right sides form the bottom field alone and sub picture data thus configured is magnified and displayed. When the data available only one of the fields is magnified and displayed, the same data is repeatedly displayed. As a result, lines appear to be wobbly on a display screen.

### Means for Solving the Problem

In order to solve the foregoing problem, a video signal processing device according to the present invention comprises:
a sub picture buffer for temporarily storing top field sub picture data and bottom field sub picture which have been subjected to run length compression;
a sub picture magnifying/demagnifying unit for subjecting sub picture data read from the sub picture buffer to a display magnification process accompanied by the interpolation of line data;
a sub picture output buffer for temporarily storing the sub picture data for which the display magnification process has been implemented by the sub picture magnifying/demagnifying unit;
a video buffer for temporarily storing video packet data; and
a video decoding unit for decoding video packet data read from the video buffer and sub picture data for which the display magnification process has been implemented and which is read from the sub picture output buffer, the video decoding unit further combining the decoded sub picture data with the decoded video packet data and outputting combined data thus obtained.

Thus constituted, the magnification ratio of the sub picture data can be changed independently from the video packet data in a digital video reproduction device such as a DVD reproduction device. Therefore, the display magnification process can be favorably performed in compliance with a data format of the sub picture data.

According to a preferable mode of the present invention, in the process of the interpolation of line data, the sub picture magnifying/demagnifying unit interpolates the line data of the field not having color data by using the line data of the field having color data in the case where there is any line not having the color data in either the top field or the bottom field. According to this mode, the phenomenon in which the lines appear to be wobby on a display screen can be prevented from happening.

According to another preferable mode of the present invention, in the interpolation process, the sub picture magnifying/demagnifying unit sets the line data of the field having as much color data as a certain number of or more pixels in both of the fields in the case where the top field and the bottom field both have color data. According to this mode, the phenomenon in which the lines appear to be wobbly on the display screen can be prevented from happening.

According to still another preferable mode of the present invention, in the process of the interpolation of the line data, the sub picture magnifying/demagnifying unit does not repeatedly use the line data in any line having at lest a certain number of pixels irrespective of the magnification ratio. According to this mode, in the process of scale up in the vertical direction, horizontal lines can be prevented from being thickened even if there is sub picture data drawn with a line of one pixel subject to the line data interpolation.

According to still another preferable mode of the present invention, the sub picture data stored in the sub picture buffer is data which is generated based on data read from an optical recording medium. According to still another preferable mode of the present invention, the video signal processing device further comprises a signal reproduction unit for reading the sub picture data from a recording medium on which the sub picture data is recorded. According to still another preferable mode of the present invention, the video signal processing device further comprises the recording medium or a device for driving the recording medium. According to still another preferable mode of the present invention, the sub picture data stored in the sub picture buffer is data which is fetched through a communication device. According to still another preferable mode of the present invention, the video signal processing device further comprises a display unit for displaying images decoded by the video decoding unit.

### Effect of the Invention

According to the present invention, in a digital video reproduction device such as a DVD reproduction device, a magnification ratio of sub picture data can be changed independently from video packet data. Accordingly, a display magnification process can be favorably performed incompliance with a data format of the sub picture data.

### BRIEF DESCRIPTION OF THE DRAWINGS

FIG. 1 is a block diagram illustrating a constitution of a disc reproduction device comprising a video signal processing device according to a preferred embodiment of the present invention.

FIG. 2 is an illustration of a problem generated when sub picture data is magnified and displayed according to the preferred embodiment.

FIG. 3 is an illustration of an operation executed when the sub picture data is magnified and displayed according to the preferred embodiment.

FIG. 4 is an illustration of another problem generated when the sub picture data is magnified and displayed according to the preferred embodiment.

FIG. 5 is a drawing illustrating an example in which the sub picture data is magnified and displayed according to a conventional technology.

FIG. 6 is a drawing illustrating an example in which the sub picture data is demagnified and displayed according to the conventional technology.

### DESCRIPTION OF THE REFERENCE SYMBOLS

A optical disc

M memory

1 disc drive

2 signal reproduction unit

3 data transfer module

4 data buffer

5 video/audio buffer

6 header analyzing unit

7 sub picture buffer

8 sub picture magnifying/demagnifying unit

9 sub picture output buffer

10 AV decoding unit

11 monitor

### PREFERRED EMBODIMENT OF THE INVENTION

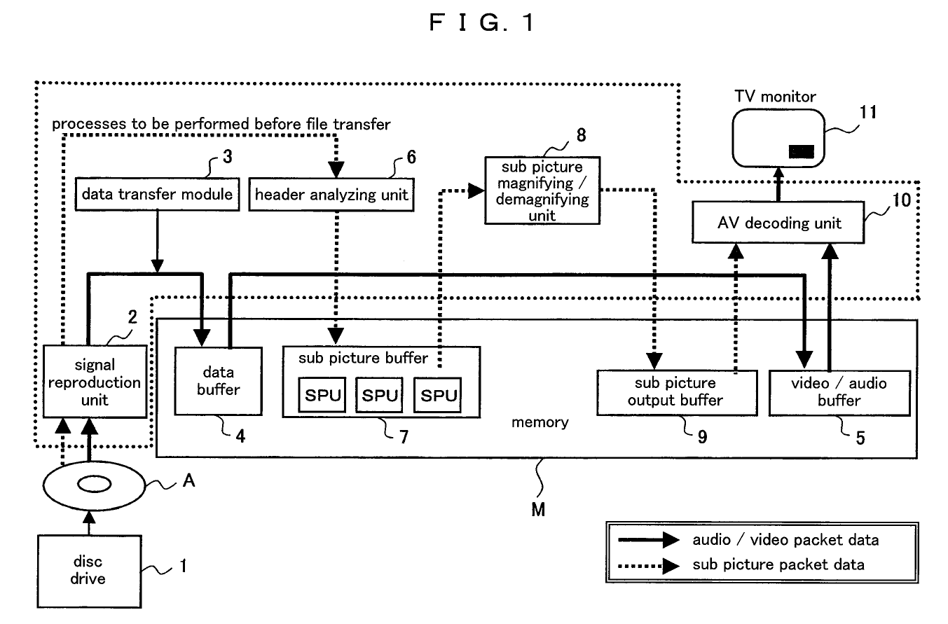

Hereinafter, a preferred embodiment of a video signal processing device according to the present invention is described in detail referring to the drawings. FIG. 1 is a block diagram illustrating a constitution of a disc reproduction device comprising a video signal processing device according to the preferred embodiment. The disc reproduction device comprises a disc drive 1, a signal reproduction unit 2, a data transfer module 3, a data buffer 4, a video/audio buffer 5, a header analyzing unit 6, a sub picture buffer 7, a sub picture magnifying/demagnifying unit 8, a sub picture output buffer 9, an AV decoding unit 10, and a monitor 11. A reference symbol A shown in the drawing denotes a disc such as DVD.

The disc drive 1 controls the rotation of the disc A. The signal reproduction unit 2 optically reads information recorded on the disc A, converts the read information into an electrical signal, performs modulation and error correction, which are in conformity with DVD specifications, for the converted electrical signal, and separates the adjusted electrical signal into video/audio packet data and sub picture packet data. The data transfer module 3 controls the data transfer of the video/audio packet data generated by the signal reproduction unit 2. The data buffer 4 temporarily stores therein the video/audio packet data transferred by the data transfer module 3. The video/audio buffer 5 temporarily stores therein the video/audio packet data transmitted from the data buffer 4 so that the said packet data can be decoded. The header analyzing unit 6 analyzes header information in the sub picture packet data generated by the signal reproduction unit 2 to thereby obtain information of the main video signal (video packet data), attribute information, information of the storage location of the sub video signal (sub picture packet data), and the like. The sub picture buffer 7 temporarily stores therein the sub picture packet data along with the sub picture information obtained by the header analyzing unit 6. The sub picture magnifying/demagnifying unit 8 provides a display magnification process, such as magnification or demagnification, to the sub picture packet data read from the sub picture buffer 7, and also provide processing for preventing line wobbling, which may otherwise occur on a display screen, to the sub picture packet data. The sub picture output buffer 9 temporarily stores therein the magnified or demagnified sub picture packet data so that the said packet data can be decoded. The AV decoding unit 10 decodes the video/audio packet data supplied from the video/audio buffer 5 and the magnified or demagnified sub picture packet data supplied from the sub picture output buffer 9, and combines the decoded video/audio packet data (main video signal) with the decoded sub picture packet data (sub video signal) to thereby generate a video signal, and then, outputs the generated video signal for display. The monitor 11 displays the video signal decoded and then combined by the AV decoding unit 10. A reference symbol M shown in the drawing denotes a memory including the data buffer 4, video/audio buffer 5, sub picture buffer 7 and sub picture output buffer 9. In the present preferred embodiment, the video/audio packet data corresponds to video packet data, while the sub picture packet data corresponds to sub picture data.

The operation of the video signal processing device according to the present preferred embodiment thus constituted is described below. The disc drive 1 controls the rotation of the disc A. The signal reproduction unit 2 optically reads information recorded on the disc A, and converts the read information into an electrical signal (high-frequency signal). The signal reproduction unit 2 reproduces a high-frequency signal by performing demodulation and then error correction conformable to the DVD specifications for a high-frequency signal obtained by the reproduction process by the signal reproduction unit 2. The signal reproduction unit 2, in reproducing the high-frequency signal, separates the high-frequency signal into video/audio packet data and sub picture packet data. The reproduced video/audio packet data is transferred to the data buffer 4 by the data transfer module 3, and further transferred to the video/audio buffer 5. Meanwhile, the reproduced sub picture packet data is analyzed by the header analyzing unit 9, and then stored in the sub picture buffer 7 along with analysis result information. Header information used here is information defined by the AVI (Audio Video Interleaving) Standards, or the like, including information of the main video size, attribute information, information of storage location of the sub picture packet, and the like. The sub picture magnifying/demagnifying unit 8 reads the sub picture packet data from the sub picture buffer 7, and provides a display magnification process, such as magnification or demagnification, to the read sub picture packet data. The sub picture magnifying/demagnifying unit 8 stores the sub picture packet data whose display magnification was processed in the sub picture output buffer 9. The video/audio packet data stored in the video/audio buffer 5 and the sub picture packet data whose display magnification was processed and which is stored in the sub picture output buffer 9 are sent out to the AV decoding unit 10. The AV decoding unit 10 generates main video signal and sub video signal by decoding the video/audio packet data and the magnified or demagnified sub picture packet data. The AV decoding unit 10 combines the main video signal obtained from its decoding process with the sub video signal obtained from its decoding process, and sends out a combined video signal thereby obtained to the monitor 11. The monitor 11 displays an image of the combined video signal.

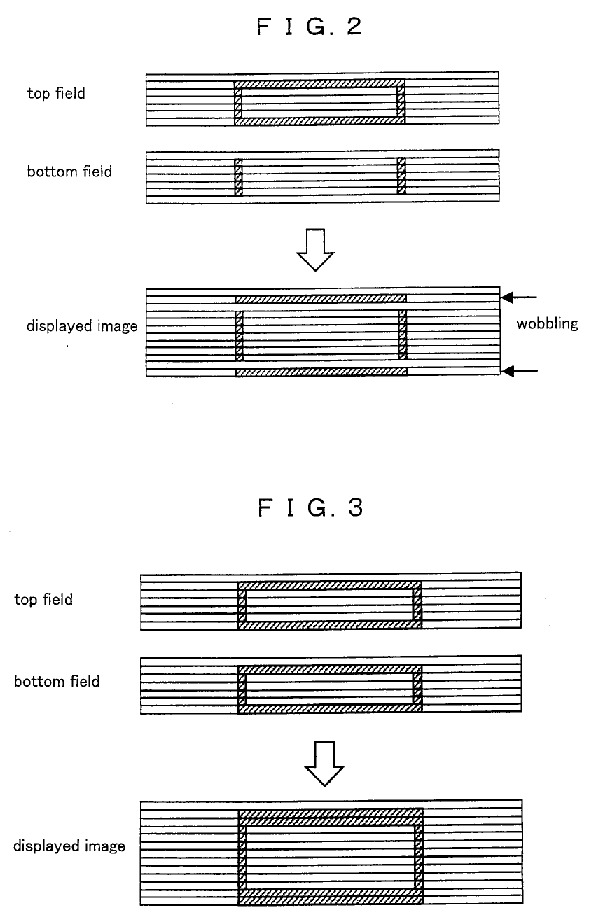

As already described referring to FIG. 2, in the case where there is any line in which the color data is set in only either the top field or the bottom field in sub picture packet data, the lines appear to be wobbly. The sub picture magnifying/demagnifying unit 8 controls the wobble of the lines. More specifically, the sub picture magnifying/demagnifying unit 8 prevents the phenomenon in which the lines appear to be wobbly from happening by interpolating the line data as illustrated in FIG. 3 when the sub picture packet data is subjected to the display magnification process.

The interpolation of line data by the sub picture magnifying/demagnifying unit 8, is performed through one of or a combination of the processes described below.

First Process

In the process of the interpolation of line data, in the case where one of the top field and the bottom field has any line with no color data, the sub picture magnifying/demagnifying unit 8 interpolates the line data in the field having no color data by using the line data in the field having color data. In other words, a higher priority is placed on the color data.

Second Process

In the process of the interpolation of line data, in the case where the top field and the bottom field both have color data, the sub picture magnifying/demagnifying unit 8 sets the line data in the field having as much color data as a certain number of or more pixels in both of the fields.

Third Process

While the top field is being subjected to the process, the line data in the top field is set. While the bottom field is being subjected to the process, the line data in the bottom field is set.

When the sub picture magnifying/demagnifying unit 8 interpolates line data as above, the phenomenon in which the lines appear to be wobbly can be effectively prevented from happening.

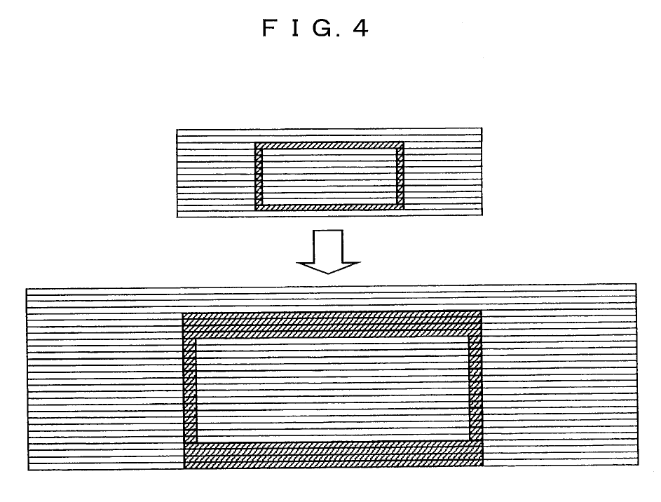

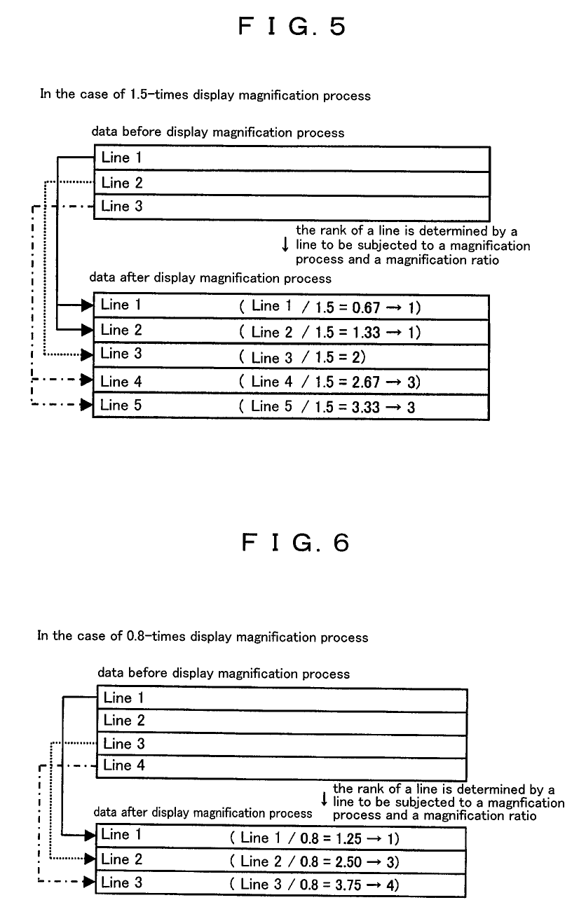

When the sub picture magnifying/demagnifying unit 8 interpolates line data as described before, there may be cases where a large difference in thickness between vertical and horizontal lines occurs in some of the line data. In the process of scale-up in the vertical direction, for example, as illustrated in FIG. 4, with a state where there is sub picture packet data drawn with a line of one pixel subject to line data interpolation in view, when a process of scale-up is performed by 200% in X and Y directions, a horizontal lines becomes twice as thick as a vertical line. In order to avoid this, the following rule needs to be observed: as far as any line where the number of pixels in the horizontal direction is equal to or more than an overall average number of pixels is concerned, line data in such a line is not repeatedly used irrespective of a magnification ratio in a display magnification process. By following this rule, horizontal lines can be prevented from being thickened.

### INDUSTRIAL APPLICABILITY

The video signal processing device according to the present invention is useful when a process such as magnification or demagnification is performed in compliance with a data format of sub picture data in a digital video reproduction device such as a DVD reproduction device.

What is claimed is:

1. A video signal processing device comprising:
a sub picture buffer for temporarily storing top field sub picture data and bottom field sub picture data which has been subjected to run length compression;
a sub picture magnifying/demagnifying unit for subjecting sub picture data read from the sub picture buffer to a display magnification process accompanied by the interpolation of line data;
a sub picture output buffer for temporarily storing the sub picture data for which the display magnification ratio conversion process is implemented by the sub picture magnifying/demagnifying unit;
a video buffer for temporarily storing video packet data; and
a video decoding unit for decoding video packet data read from the video buffer and sub picture data for which the display magnification process is implemented an which is read from the sub picture output buffer, the video decoding unit further combining the decoded sub picture data with the decoded video packet data and outputting combined data thereby obtained.

2. The video signal processing device as claimed in claim 1, wherein
the sub picture magnifying/demagnifying unit, in a process of the interpolation of line data, interpolates the line data of the field not having color data by using the line data of the field having color data in the case where there is any line not having color data in either the top field or the bottom field.

3. The video signal processing device as claimed in claim 1, wherein
the sub picture magnifying/demagnifying unit, in a process of the interpolation of line data, sets the line data of the field having as much color data as a certain number of or more pixels in both of the fields in the case where the top field and the bottom field both have color data.

4. The video signal processing device as claimed in claim 1, wherein
the sub picture magnifying/demagnifying unit, in a process of the interpolation of line data, does not repeatedly use the line data in any line having at lest a certain number of pixels irrespective of the magnification ratio.

5. The video signal processing device as claimed in claim 1, wherein
the sub picture data stored in the sub picture buffer is data which is generated based on data read from an optical recording medium.

6. The video signal processing device as claimed in claim 5, further comprising a signal reproduction unit for reading the sub picture data from a recording medium on which the sub picture data is recorded.

7. The video signal processing device as claimed in claim 6, further comprising the recording medium or a device for driving the recording medium.

8. The video signal processing device as claimed in claim 1, wherein
the sub picture data stored in the sub picture buffer is data which is fetched through a communication device.

9. The video signal processing device as claimed in claim 1, further comprising a display unit for displaying images decoded by the video decoding unit.
